(19) United States
(12) Patent Application Publication
(10) Pub. No.: US 2013/0311563 A1
(43) Pub. Date: Nov. 21, 2013

(54) Determining Characteristics of Participants in a Social Network

(71) Applicants: Bernardo Huberman, Palo Alto, CA (US); Sitaram Asur, Mountain View, CA (US); Daniel Romero, Ithaca, NY (US); Wojciech Galuba, Lausanne Vaud (CH)

(72) Inventors: Bernardo Huberman, Palo Alto, CA (US); Sitaram Asur, Mountain View, CA (US); Daniel Romero, Ithaca, NY (US); Wojciech Galuba, Lausanne Vaud (CH)

(21) Appl. No.: 13/885,973

(22) PCT Filed: Feb. 11, 2011
(86) PCT No.: PCT/US11/24590

§ 371 Date: May 16, 2013

(51) Int. Cl. H04L 29/08

(52) U.S. Cl. CPC H04L 67/22
USPC 709/204

(57) ABSTRACT

Implementations disclosed herein relate to determining the influence and/or passivity of participants in a social network. In one implementation, a processor 101 determines the relative influence of a first participant based on the passivity of participants influenced by the first participant. In one implementation, the processor 101 determines the relative passivity of a first participant based on the influence of other participants.

### BACKGROUND

Communication within social networks is becoming increasingly popular. A participant may propagate, content through the social network, such as by forwarding, linking, or paraphrasing content from another participant. Each participant may have a set of followers within the social network able to view content posted by the particular participant. For example, a first participant may post content viewable by the first participant's followers, including a second participant, and the second participant may post the content viewed from the first participant to make the content available to the second participant's followers.

### BRIEF DESCRIPTION OF THE DRAWINGS

The drawings illustrate example implementations. For example, the drawings show methods performed in an example order, but the methods may also be performed in other orders. The following detailed description references the drawings, wherein:

FIG. 1 is a block diagram illustrating one example of an electronic device.

FIG. 2 is a flow chart illustrating one example of a method to determine the relative influence of a participant in a social network.

FIG. 3 is a flow chart illustrating one example of a method to determine the influence of a participant in a social network.

FIG. 4 is a flow chart illustrating one example of a method to determine the relative influence of a participant in a social network.

FIG. 5 is a flow chart illustrating one example of a method to determine the passivity of a participant in a social network.

FIG. 6 is a diagram illustrating one example of a chart to predict the characteristics of a participant in a social network based on the participant's relative passivity.

### DETAILED DESCRIPTION

In one implementation, a system for evaluating the propagation of information in a social network determines the relative influence of participants in the social network. The relative influence of a participant may be, for example, the relative ability of the participant to have his content shared by other participants receiving the content. The influence of a first participant may be determined based on the number of participants influenced by the first participant, meaning the number of participants sharing content received from the first participant, compared to a relative passivity level of each of the influenced participants. The relative passivity of a participant may be, for example, the relative rate of failing to share communications received on the social network. The level of passivity of influenced participants may be used to determine influence because a more influential participant may be able to influence participants that have a low rate of sharing communications, such as participants that are difficult to influence.

The relative influence of a participant in a social network may be useful for marketing purposes. For example, an entity, such as a company, non-profit, or ideological group, may determine its relative influence in a social network compared to as competitors. An entity may determine which participants in the social network should be targeted due to their ability to influence a large number of other participants. In some cases, the influence may be determined on a subset of users or on communications related to a particular topic to further refine the results. In some implementations, the influence of a group of participants may be determined, such as a comparison of influence of particular groups of participants or a comparison of influence of particular topics.

A relative passivity score also may be assigned to each participant in the social network. The relative passivity score may be used to determine the relative influence of participants. In addition, the relative passivity of participants may be used to infer characteristics about social network participants. For example, participants with a high relative passivity indicating a lower rate of sharing received communications may be more likely to be automated participants or spammers.

The passivity of a participant may be determined, for example, based on a rate of failing to share received communications compared to the influence of the participant associated with each of the received communications. The influence of the participant may be compared to the rate of failing to share the communication because a failure to share a communication from a more influential participant may indicate that a participant is more passive than a participant that fails to share a communication from a less influential participant.

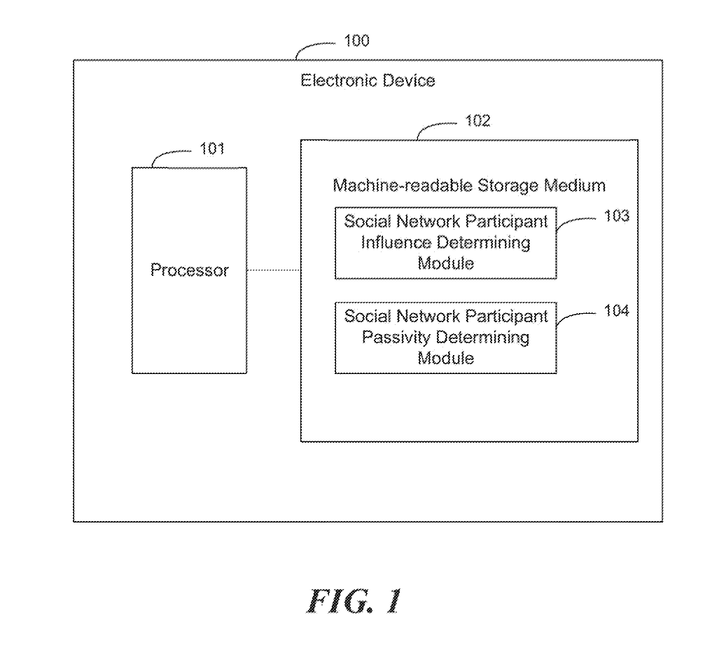

FIG. 1 is a block diagram illustrating one example of an electronic device 100. The electronic device 100 may be, for example, a personal computer, mobile computing device, or server. The electronic de 100 may include a processor 101 and a machine-readable storage medium 102.

The electronic device 100 may be used to determine the characteristics of participants in a social network. The social network may be, for example, a social network on a social networking computing platform. The social networking computing platform may include servers for storing communications between participants. The social network computing platform may include multiple different social networks. The networks may be formed by relationships between participants, such as where participants join a group or associate with one another. Relationships may be single direction, such as where participant X may view participant Y's communications, or bi-directional, such as where participant X may view participant Y's communications and participant Y may view participant X's communications. Participants may post communications, such a messages, links, photographs, videos, or other information, using an electronic device, and other participants may view the communications on an electronic device. Participants may receive communications directly from other participants or may be able to view communications posted by other participants. Participants may communicate with one another on the social network, for example, using a network, such as the Internet.

The processor 101 may be any suitable processor, such as a central processing unit (CPU), a semiconductor-based microprocessor, or any other device suitable for retrieval and execution of instructions. In one implementation, the electronic device 100 includes logic instead of or in addition to the processor 101. As an alternative or in addition to fetching, decoding, and executing instructions, the processor 101 may include one or more integrated circuits (ICs) (e.g., an application specific integrated circuit (ASIC)) or other electronic circuits that comprise a plurality of electronic components for performing the functionality described below. In one implementation, the electronic device 100 includes multiple processors. For example, one processor may perform some functionality and another processor may perform other functionality.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101.

The machine-readable storage medium 102 may include a social network participant influence determining module 103 and a social network participant passivity determining module 104. The social network participant influence determining module 103 may include instructions executable by the processor 101 to determine the influence of participants in a social network. In some cases, the influence of a participant may be determined across multiple social networks, such as where the participant posts content on multiple social networks.

The relative influence of a participant may indicate the ability of the participant to propagate content through the social network relative to other participants. In one implementation, the relative influence of a first participant may be determined based on the number of participants influenced by the first participant and the level of passivity of each influenced participant. The level of passivity may be determined, for example, using the social network participant passivity determining module 104.

The social network participant passivity determining module 104 may include instructions executable by the processor 101 to determine the relative passivity of participants in a social network. The passivity of as participant in the social network may indicate the likelihood of the participant to refrain from sharing communications received in the social network. In one implementation, the passivity of a participant is determined based on the rate of failing to share communications received from each participant and the influence of each of the associated participants. The influence of the participants may be calculated, for example, using the social network participant influence determining module 103.

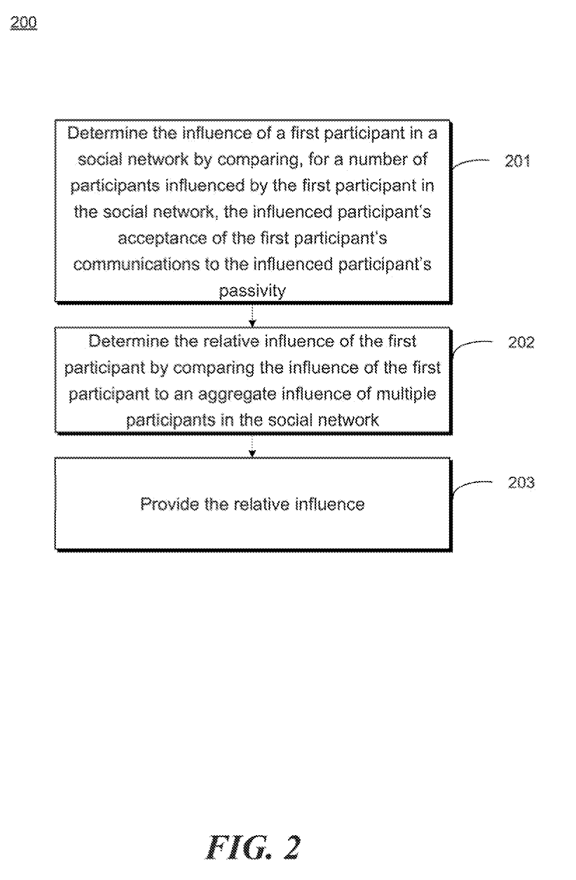

FIG. 2 is a flow chart illustrating one example of a method 200 to determine the relative influence of a participant in a social network. The social network may be any suitable social network, such as a network where participants associate themselves with one another and share messages. The relative influence of a participant in a social network may be determined based on the number of participants sharing content received from the participant and the relative passivity of each of those participants. For example, a first participant may be more influential if participants that rarely share communications share the first participant's communications than if participants that share many communications share the first participant's communications. The relative influence of participants in the social network may be used to rank the level of influence of the participants. The relative influence of the participants may then be output for use, such as, as for analyzing how to more effectively propagate a message through the social network. The method 200 may be executed, for example, on the electronic device 100, such as by the processor 101 executing, instructions in the social network participant influence determining module 103.

Beginning at 201, a processor determines the influence of a first participant in a social network by comparing, for a number of participants influenced by the first participant in the social network, the influenced participants acceptance of the first participant's communications to the influenced participant's passivity. Acceptance of a communication may be indicated, for example, by sharing a communications, such as a communication posted by a first participant copied and posted by a second participant or a communication posted by a second participant mentioning a portion of a communication posted by a first participant. The acceptance of the first participants communications may include an amount of influence accepted, such as by sharing communications, from the first participant compared to an amount of influence accepted from other participants. For example, the first participant may post 10 messages and a second participant may share 3 of the 10 posted messages. The second participant may share a larger or smaller percentage of communications received from other participants. If the second participant shares a large percentage of communications from the first participant but also shares a large percentage of communications from other participants, the first participant may be less influential than in a scenario where the second participant shares large percentage of communications from the first participant but a low percentage of communications from other participants.

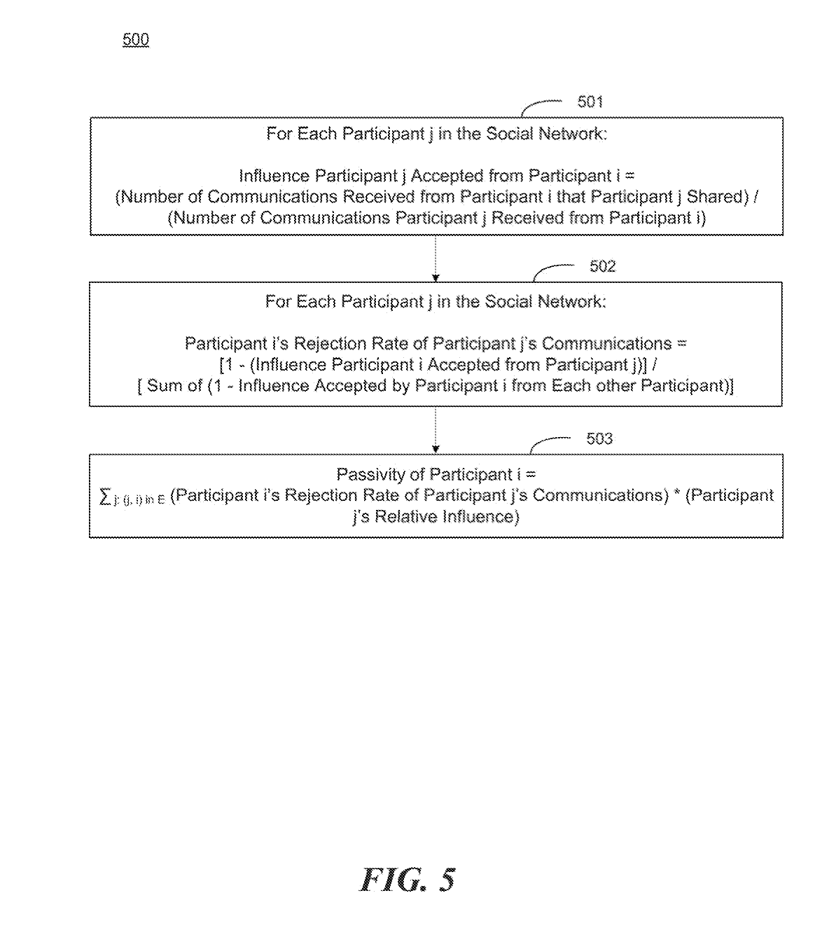

The influenced participants' passivity may be taken into account when determining influence. The influenced participants' level of passivity may be indicated by the rate at which influenced participants fail to share communications received from participants in the social network. For example, a first participant may be more influential if the first participant is able to influence participants that have a high level of passivity, indicating a high level of failing to share communications. The level of passivity may be determined, for example, using a method 500 described in FIG. 5.

In one implementation, the influence of participants in a social network is determined by creating a directed graph. For example, each node in the graph may represent a participant in the social network. In some implementations, the nodes in the graph represent participants with a particular degree of participation, such as participants posting three or more communications. An edge may be created between two nodes and i and j where j is a follower of i and j. In some implementations, an edge is created between two nodes i and j where j is a follower of i, and j shred at least one of i's communications. A weight may be created for the edges. For an edge between nodes i an j, the weight may indicate, for example, the number of i's communications that j shared divided by the number of i's communications. In some cases, the weight may involve a subset of communications, such as communications on a particular topic.

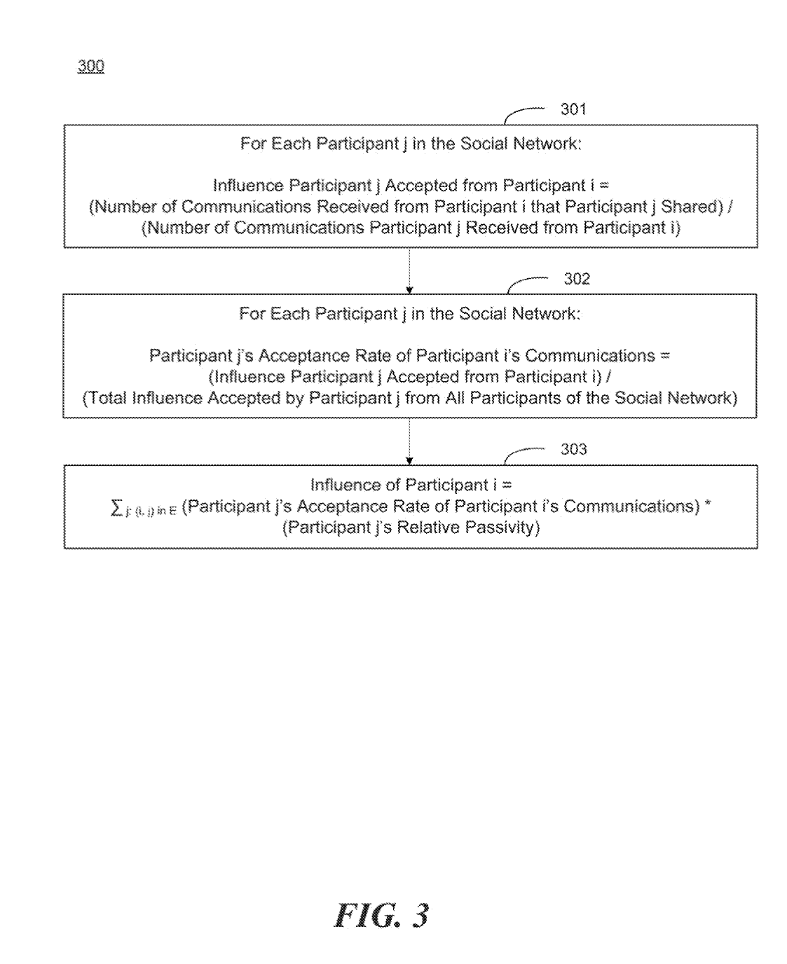

The method 200 is described in conjunction with FIG. 3. FIG. 3 is a flow chart illustrating one example of a method 300 to determine the influence of a participant in a social network. Example 300 illustrates determining the influence of a Participant i in the social network. The same steps may be completed to determine the influence of each participant within the social network. Other methods for determining the relative influence of a participant in a social network are also contemplated.

Beginning at 301, a processor determines for each Participant j in the social network, the amount of influence Participant j accepted from Participant i. For example, the processor determines for each participant in the network, or a subset of participants in the network, the amount of influence accepted from Participant i. The amount of influence may be, for example, the weight on an edge in a directed graph representing communications in the social network. In some cases, a Participant j may not have accepted any influence form Participant i, such as where Participant j is not associated with Participant i, where Participant j does not view Participant i's communications, or where Participant i has not posted any communications. The amount of influence of Participant i may be determined by the number of communications received from Participant i that Participant j shared divided by the total number of communications received from Participant i. Communications received from Participant i may be communications that Participant j had access to, such as communications specifically tailored to Participant j or communications posted by Participant i that may be viewed by Participant j. In some implementations, the communications may be considered to be received by Participant j whether or not Participant j actually viewed the communication.

As an example, Participant A may have followers Participant E, Participant F, and Participant G. Participant A may post 10 links viewable by A's followers. Participant E may share 3 of the links, Participant F may share 8 of the links, and Participant G may share 4 of the links. Participant E's amount of accepted influence would be 0.3, Participant F's amount of accepted influence would be 0.8, and Participant FGs amount of accepted influence would be 0.4.

Moving to 302, the processor determines for each Participant j in the social network, Participant j's acceptance rate of Participant is communications. The acceptance rate may include, for example, the amount of influence accepted from Participant i's communications compared to an amount of influence accepted from communications generally. The amount of influence accepted from communications generally may be determined based on the sum of the determination of step 301 for each participant in the social network from which Participant j received some communications.

As an example, Participant E may follow Participant A, Participant B, and Participant F. Participant E may accept an amount of influence of 0.3 from Participant A. as calculated above. Participant E may accept an amount of influence of 0.5 from Participant B and an amount of influence 0.8 from Participant F. The acceptance rate of Participant E of communications from Participant A may be determined by the following: [amount of influence accepted from Participant A]/[(amount of influence accepted from Participant A)+(amount of influence accepted from Participant B)+(amount of influence accepted from Participant F)]=(0.3)/(0.3+0.5+0.8)=0.19. Participant F may follow Participant A and Participant D, and Participant F may accept 0.7 of influence from Participant D. Participant F's acceptance rate of Participant As communications may be the amount of influence accepted from A divided by the total amount of influence accepted by Participant F. Participant F's acceptance rate may be 0.8/(0.8+0.7)=0.53. Participant G may follow Participant A and Participant C. Participant G's amount of influence accepted from Participant A is 0.4 as shown above. Participant G's amount of influence accepted from Participant C may be, for example, 0.2. Participant G's rate of acceptance of Participant A would be 0.4/(0.4+0.2)=0.67. Thus, Participant G has a higher normalized rate of acceptance of Participant A than Participants E and F.

Proceeding to 303, the processor determines the influence of Participant i. The influence of Participant i may be determined by multiplying the acceptance rate of each influenced participant by the participant's corresponding passivity. The sum for each influenced participant may then be used to calculate the influence of Participant i.

For example, the passivity of Participant E may be 0.1, the passivity of Participant F may be 0.7, and the passivity of Participant C may be 0.8. The passivity may be determined for example, by comparing the rate of failing to forward communications to the level of influence of the participants whose communications were received. The influence of Participant A may be determined by the following: (Participant E Acceptance Rate*Participant E Passivity)+(Participant F Acceptance Rate*Participant F Passivity)+(Participant G Acceptance Rate*Participant G Passivity)=(0.19*0.1)+(0.53*0.7)+(0.67*0.8)=0.93.

Referring back to FIG. 2 and continuing to 202, the processor determines the relative influence of the first participant by comparing the influence of the first participant to an aggregate influence of multiple participants in the sodas network. The relative influence of a participant may be useful for determining which participants are more or less influential than other participants.

Participant i's influence may be determined, for example, by dividing the influence of Participant i by the sum of the influence of each participant in the social network. As an example, Participant A may have an influence level of 0.93 as determined above, Participant B may have an influence level of 0.4, Participant C may have an influence level of 0.55, Participant D may have an influence level of 0.6, Participant E may have an influence level of 0.8, Participant F may have an influence level of 0.82, and Participant G may have an influence level of 2. The relative influence of Participant A may be determined by the following: (influence of Participant A)/[(Influence of Participant A)+(Influence of Participant B)+(Influence of Participant C)+(Influence of Participant D)+(Influence of Participant E)+(Influence of Participant F)+(Influence of Participant G)]=0.93/(0.93+0.4+0.55+0.6+0.8+0.82+0.2)=0.22. The relative of influence of Participant B may be determined by (Influence of Participant B)/[(Influence of Participant A)+(Influence of Participant B)+(Influence of Participant C)+(Influence of Participant D)+(Influence of Participant X)+(Influence of Participant Y)+(Influence of Participant Z)]=0.09. Thus, Participant A is more influential than Participant B.

Moving to 203, the processor provides the relative influence. A calculated number of relative influence, a relative ranking, or other relative comparison may be provided. The relative influence information may be provided in any suitable manner. For example, the relative influence information may be displayed on a display device, transmitted to another electronic device, or stored for later use. The relative influence may be used to evaluate participants in the social network. In some cases, the relative influence information may be used, for example, to help an entity position itself to better propagate a message through the social network, such as by targeting more influential followers.

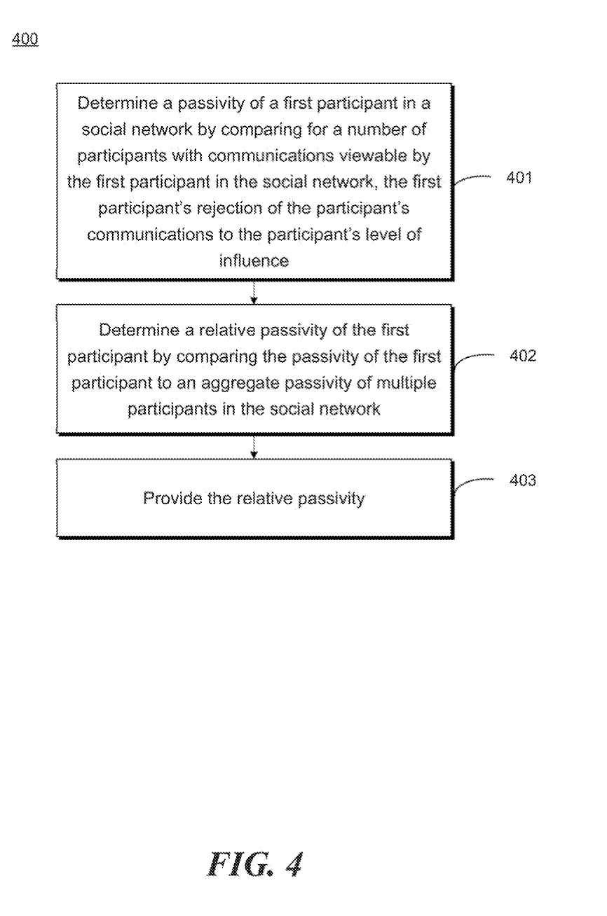

FIG. 4 is a flow chart illustrating one example of a method 400 to determine the relative passivity of a participant in a social network. The social network may be, for example, a network where participants post links, messages, videos, and photographs to followers on the social network. The relative passivity of a participant in a social network may be used, for example, to determine the influence of a participant or to determine likely characteristics of the participant. The passivity of a participant may indicate a participant's rejection of communications. The passivity of a first participant may be based on the influence of participants posting communications viewable by the first participant. For example, a first participant that fails to share communications from influential participants may be less passive than a second participant that fails to share communications from less influential participants. The relative passivity of participants in a social network may be determined to compare the passivity of the participants. The method 400 may be executed on the electronic device 100, such as by the processor 101 executing instructions in the social network participant passivity determining module 104.

Beginning at 401, a processor determines the passivity of a first participant in a social network by comparing for a number of participants with communications viewable by the first participant, the first participant's rejection of the participant's communications to the participant's level of influence. A participant may, for example, accept a communication by sharing it, or reject a communication by refraining from sharing it. The passivity of a first participant may be determined based on the influence level of participants with communications rejected by the first participant. If a participant rejects a communication from a more influential participant, the participant may be more passive than a participant that rejects a communication from a less influential participant.

In one implementation, the passivity of participants in a social network is determined by creating a directed graph, which may be the same or different from a directed graph used to compute influence. Each node in the graph may represent a participant in the social network, such as where each node represents participants posting three or more communications. An edge may be created between two nodes i and j where j is a follower of i and j. In some implementations, an edge is created between two nodes i and j where j is a follower of i and j shared one of i's communications. A weight may be created for the edges. The weights may indicate, for example, for an edge between nodes i an j the number of i's communications that j shared divided by the number of i's communications. The weight may be the same weight used for determining influence. In one implementation, the weight w for influence may be altered as 1 minus w for passivity because the percentage of communications not shared may be equal to 1 minus the percentage of communications shared.

In one implementation, a processor determines the rejection of communications by the amount of influence rejected, such as by the number of communications not shared divided by the number of communications received. In some cases, it may be easier to determine the rejection based on subtracting the amount of acceptance from 1 because it may be easier to gather information on which communications were shared than on which communications were available and not shared. The percentage of influence rejected plus the percentage of influence accepted should equal 1 in a system where a communication is either accepted or rejected, such as either shared or not shared. In some cases, the amount of rejection in relation to a first participant is then normalized by the total amount of communications rejected from the first participant and other participants.

The method 400 is discussed in conjunction with FIG. 5. FIG. 5 is a flow chart illustrating one example of a method 500 to determine the passivity of a Participant i in a social network. Beginning at 501, a processor determines for each Participant j in a social network, the influence Participant j accepted from Participant i. The amount of influence accepted by each Participant j may be the same as the step 301 from FIG. 3. As an example, Participant A may receive 3 communications from Participant B, 0 Communications from Participant C, 0 communications from Participant D, 0 communications from Participant E, 0 communications from Participant F, and 5 communications from Participant G. For example, Participant A may be a follower of Participants B and G. Participant A may share 2 of the 8 communications received from Participant B and 4 of the 5 communications from Participant G. Participant A's amount of influence accepted from Participant B is 0.25, and Participant A's amount of influence accepted from Participant G is 0.8.

Proceeding to 502, the processor determines for each Participant j in the social network Participant i's rejection rate of Participant j's Communications. The rejection rate may be determined by 1−the influence accepted from Participant j compared to the total rejection all the participants. The rejection rate of Participant A of Participant B may be determined by the following: (1−amount of accepted influence of Participant B)/[(1−amount of accepted influence of Participant B)+(1−amount of accepted influence of Participant G)=(1−0.2)/[(1−0.2)+(1−0.8)]=0.79. The rejection rate of Participant A of Participant C may be (1−0.8)/[(1−0.25)+(1−0.8)]=0.21.

Continuing to 503, the processor determines the passivity of Participant i. The passivity of a Participant i may be based on Participant i's rejection of each participant from which Participant i receives communications and the influence of each of those participants. A high rejection rate of an influential participant may indicate a more passive participant than a low rejection rate of a less influential participant. The passivity may be determined by the sum of the rejection rate times the influence for each Participant j sending a communication to Participant i.

As an example, Participant A's passivity may be determined by the following: (Participant A's rejection rate of Participant B Participant B's influence)+(Participant A's rejection rate or Participant G*Participant G's influence). The influence of Participant B may be, for example, 0.4, and the influence of Participant G may be 0.2. The influence may be determined using the method 200 of FIG. 2. Participant A's passivity=(0.79*0.4)+(0.21*0.2)=0.36.

Referring back to FIG. 4 and continuo to 402, the processor determines a relative passivity of the first participant by comparing the passivity of the first participant to an aggregate passivity of multiple participants in the social network. For example, the relative passivity of a participant may be used to compare the passivity of multiple participants in the social network. The passivity of the first participant may be divided by the sum of the passivity of each participant in the social network or a subset of the participants in the social network. For example, Participant A's passivity is 0.36 as determined above. Participant B's passivity may be 0.4, Participant C's passivity may be 0.2, Participant D's passivity may be 0, Participant X's passivity may be 0.1, Participant Y's passivity may be 0.7, and Participant Z's passivity may be 0.8. The relative passivity of Participant A is 0.36/(0.36+0.4+0.2+0.1+0.8+0.8)=0.14. The relative passivity of Participant B is 0.4/(0.36+0.4+0.2+0.1+0.8+0.8)=0.17. Thus, Participant B is more passive than participant A. This may mean that it is more difficult to propagate a message through the social network with Participant B as a follower than with Participant A as a follower.

Moving to 403, the processor provides the relative passivity. For example, the processor may display the relative passivity on a display device, transmit the relative passivity to another electronic device, or store the relative passivity for later use. The provided relative passivity may be any suitable information indicating the relative passivity, such as a level of relative passivity or a ranking of participants by passivity. In some cases, the processor may provide both the relative passivity and the relative influence of one or more participants of the social network. The relative passivity may be used, for example, to determine the influence of participants in the social network. In some cases, the relative passivity of participants may be evaluated to determine how best to propagate a message through the social network.

In one implementation, characteristics of a participant may be predicted based on the participant's relative passivity. For example, participants with a relative passivity above a particular threshold or in above a particular percentile in the group may be more likely to be related to a spammer, automated participants, or suspended accounts. In some cases, a high level of passivity may correlate with participants that post communications often.

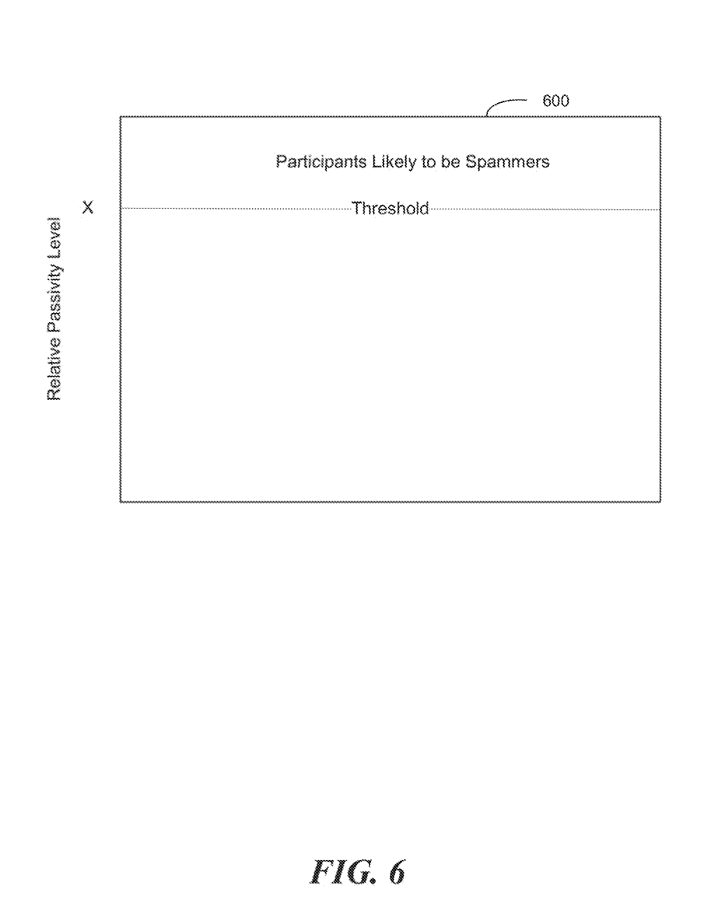

FIG. 6 is a diagram illustrating one example of a chart 600 to predict the characteristics of a participant based on the participant's relative passivity. For example, participants with a relative passivity level above a threshold X may be likely to be spammers, and participants with a relative passivity level below a threshold X may be likely to be regular participants. The passivity level may be used to predict other characteristics of participants, such as an affiliation with a particular group or a type of entity participant. In one implementation, social network participants or communications may be filtered based on the predicted characteristics. For example, the communications of participants predicted to be spammers may be filtered so that they are not viewable or shared.

Determining the influence of social network participants based on influenced participants and their passivity may lead to more accurate estimates of social network influence. Including passivity in the calculation may account for the likelihood of followers to share received content. In addition, determining the passivity of social network a participant based on the influence of the participants followed may increase the accuracy of estimating a level of rejecting received content.

1. An electronic device to determine an influence of a social network participant, comprising:
a processor to:
determine an influence of a first participant of a social network based on the number of participants of the social network influenced by the first participant and a level of passivity associated with each of the influenced participants; and
provide information about the influence of the first participant.

2. The electronic device of claim 1, wherein a participant influenced by the first participant comprises a participant that shared content received from the first participant.

3. The electronic device of claim 3, wherein the relative influence of the participant is further based on an influenced participants' level of sharing con received from the first participant compared to the influenced participant's level of sharing content received from other participants.

4. The electronic device of claim 1, wherein the level of passivity associated with an influenced participant comprises a level of failing to share communications received via the social network.

5. The electronic device of claim 1, further comprising determining the level of passivity of a participant influenced by the first participant based on the influence of participants sharing communications with the participant influenced by the first participant.

6. A method to determine the relative influence of a participant in a social network, comprising:
determining, by a processor, an influence of a first participant in a social network by comparing, for a number of participants influenced by the first participant in the social network, the influenced participant's acceptance of the first participant's communications to the influenced participant's passivity;
determining, by a processor, the relative influence of the first participant by comparing the influence of the first participant to an aggregate influence of multiple participants in the social network; and
providing, by a processor, the relative influence.

7. The method of claim 6, wherein comparing the influenced participant's acceptance of the first participant's communications comprises comparing the amount of influence accepted from the first participant relative to the amount of influence accepted from other participants.

8. The method of claim 7, wherein comparing the amount of influence accepted from the first participant comprises comparing a ratio between the number of communications received from the first participant and the number of received communications from the first participant shared with other participants in the social network.

9. The method of claim 6, wherein comparing an influenced participant's passivity comprises comparing a rate of failing to share communications received via the social network.

10. The method of claim 6, further comprising determining en influenced participants passivity based on the influence of other participants sharing communications with the influenced participant.

11. A machine readable non-transitory storage medium including ructions executable by a processor, comprising instructions to:
determine a passivity of a first participant in a social network by comparing for a number of participants with communications viewable by the first participant in the social network, the first participant's rejection of the participant's communications to the participant's level of influence;
determine a relative passivity of the first participant by comparing the passivity of the first participant to an aggregate passivity of multiple participants in the social network; and
provide the relative passivity.

12. The machine-readable non-transitory storage medium of claim 11, wherein the first participant's rejection of the participant's communications comprises the amount of influence rejected from the participant compared to the amount of influence rejected from other participants.

13. The machine-readable non-transitory storage medium of claim 12, further comprising instructions to predict characteristics of the first participant based on the relative passivity.

14. The machine-readable non-transitory storage medium of claim 11, wherein the first participant's passivity comprises a level of failing to share communications in the social network.

15. The machine-readable non-transitory storage medium of claim 11, wherein the participant's level of influence is based on the passivity of other participants accepting communications from the participant.
